(19) United States
(12) Patent Application Publication
(10) Pub. No.: US 2009/0193173 A1
(43) Pub. Date: Jul. 30, 2009

(54) SECURE VIRTUAL ENVIRONMENT FOR PROVIDING TESTS

(75) Inventors: Vishal R. Joshi, Redmond, WA (US); Lorrin G. Smith-Bates, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/021,254

(22) Filed: Jan. 28, 2008

(51) Int. Cl. G06F 12/00; G06F 9/455

(52) U.S. Cl. 711/6; 718/1; 711/E12.016

(57) ABSTRACT

Aspects of the subject matter described herein relate to a secure virtual environment for providing tests to test takers. In aspects, a testing environment is set up that includes one or more virtual machines. A view to the virtual machines is provided to a test taking station on which a test taker may interact with and configure the virtual machines. The virtual machines in the testing environment are allowed to communicate with each other but are not allowed access to resources outside of the testing environment. After the test taker indicates that the test taker is done with the test, data related to the test is collected from the virtual machines. This data may then be used to score the test taker.

### BACKGROUND

Computers have frequently been used to provide tests to people. A computer can display a multiple choice type question, display the possible answers, and receive input from a test taker as to which answer is correct. A computer can also time a test, mix up the questions given on a test, automatically score a multiple choice test, collect information about a test taker, and provide this information automatically to others.

Computer tests have been used for certification exams. If a person passes the test, the person becomes “certified” as skilled in the subject matter of the test. Certifications are often related to salary and whether a person will be hired for a position. Unfortunately, people have resorted to fraudulent mechanisms to pass certification exams.

In response, test providers have moved away from multiple choice or fill-in-the-answer type questions to simulation based tests. In a simulation based test, a user is shown a view of an application which has a subset of its features enabled and asked to complete tasks. Unfortunately, simulation based tests are expensive to create and are often frustrating to test takers as they may not provide all the paths available in fully-featured software to arrive at the correct answer.

### SUMMARY

Briefly, aspects of the subject matter described herein relate to a secure virtual environment for providing tests to test takers. In aspects, a testing environment is set up that includes one or more virtual machines. A view to the virtual machines is provided to a test taking station on which a test taker may interact with and configure the virtual machines. The virtual machines in the testing environment are allowed to communicate with each other but are not allowed access to resources outside of the testing environment. After the test taker indicates that the test taker is done with the test, data related to the test is collected from the virtual machines. This data may then be used to score the test taker.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram representing an exemplary environment in which aspects of the subject matter described herein may be implemented;

FIG. 4 is a block diagram illustrating various components that may be included in an apparatus arranged in accordance with aspects of the subject matter described herein;

FIG. 5 is a flow diagram that general represents actions that may occur on a test taking station in accordance with aspects of the subject matter described herein;

FIG. 6 is a flow diagram that generally represents exemplary actions that may be taken by an environment that hosts a virtual environment in accordance with aspects of the subject matter described herein; and

FIG. 7 is a flow diagram that generally represents exemplary actions that may occur from within a virtual machine in accordance with aspects of the subject matter described herein.

### DETAILED DESCRIPTION

### Exemplary Operating Environment

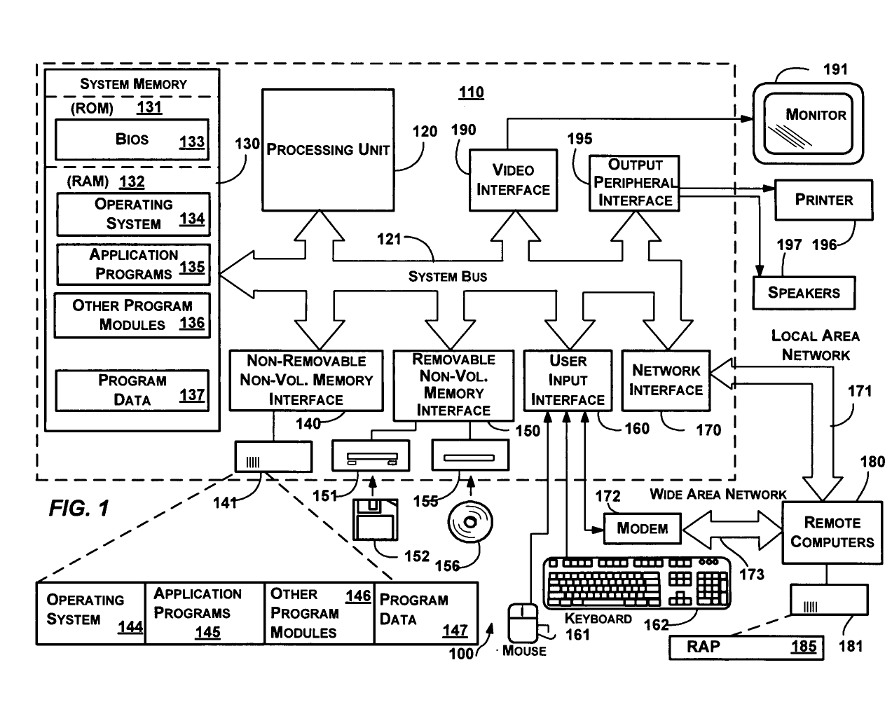

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDS) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Computer-Based Testing

As mentioned previously, computers are often used to test people. Unfortunately, people have found ways to cheat on these tests and thus devalue the passing of a test. Aspects of the subject matter described herein relate to emulation testing which may also be combined with other forms of computer testing including multiple choice, simulation, and other forms of computer testing to obtain a better measure of a test taker's skill in a particular subject matter.

In emulation testing, a virtual environment is set up with all the software that is needed for the test. The virtual environment may include one or more virtual machines. A virtual machine is a machine that, to at least some software executing on the virtual machine, appears to be a physical machine and/or a particular operating system. The physical machine which is represented via the virtual machine may or may not correspond to an actual physical machine and the operating system may or may not correspond to an actual operating system. The software may save files in a virtual storage device such as virtual hard drive, virtual floppy disk, and the like, may read files from a virtual CD, may communicate via a virtual network adapter, and so forth.

More than one virtual machine may be hosted on a single computer. That is, two or more virtual machines may execute on a single physical computer. To at least some software executing in each virtual machine, the virtual machine appears to have its own hardware even though the virtual machines hosted on a single computer may physically share one or more physical devices with each other and with the hosting operating system.

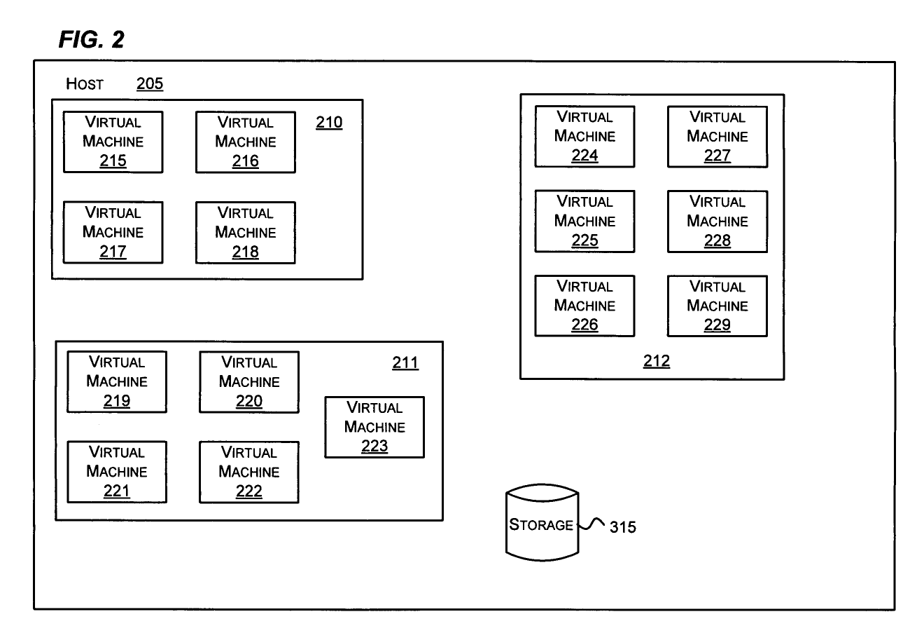

FIG. 2 is a block diagram representing an exemplary environment in which aspects of the subject matter described herein may be implemented. The environment includes a host 205, testing environments 210-212, and storage 315. The testing environment 210 may include virtual machines 215-218. The testing environment 211 may include virtual machines 219-223. The testing environment 212 may include virtual machines 224-229.

The host 205 is a computer such as the computer 110 of FIG. 1. It includes or is attached to one or more storage devices represented by the storage 315. The host 205 hosts the virtual machines 215-229 in three separate testing environments 210-212. To do this, in one embodiment, this host 205 ensures that the virtual machines in each environment can communicate with each other but cannot communicate with entities outside of their environment. For example, the virtual machine 215 can communicate with the virtual machines 216-218 and vice versa, but none of the virtual machines 215-218 can communicate with any of the virtual machines 219-229. Likewise, the virtual machines 219-223 in the environment 211 may communicated with each other but not with the virtual machines 224-229 in the environment 212.

In some embodiments, one or more virtual machines within a single environment may not be able to communicate with other virtual machines within the single environment. This may be done, for example, in response to the needs of a test. In addition, in some embodiments, a single environment may include more than one network.

The host 205 also ensures that the virtual machines do not have access to data of the host 205 that is included on the storage 315 or in the memory of the host (that is not used for the particular virtual machine). If, for example, a virtual machine gained access to host storage 315 or to the memory of the host 205, the virtual machine may be able to crash or otherwise tamper with the host 205 or machines to which the host 205 might be connected, obtain confidential information, obtain information about a test in progress so as to allow a test taker to cheat, or gain access to outside resources, e.g., on the Internet, which may not be desired for a test taking environment.

The virtual machines 215-229 may be assigned one or more virtual storage devices which may reside in memory and/or on the storage 315, but the virtual machines 215-229 are not allowed to access data outside of their virtual storage areas.

Multiple virtual machines are shown in the environments 210-212 because some tests may involve the use of more than one machine. For example, a networking test may involve setting up a DNS server, a file server, a domain controller, and one or more clients. For purposes of the test, these entities may be allowed to communicate with each other, but are not allowed to communicate with entities outside of the test environment.

Note that although in FIG. 2 there are shown multiple testing environments 210-212 on a single host 205, that in other embodiments, these environments may be distributed over many physical machines with each physical machine hosting one or more virtual machines.

It can be seen that the testing environments 210-212 illustrated in FIG. 2 are secure for testing purposes. A virtual machine may communicate with another virtual machine in its environment but may not communicate with a virtual machine in another environment. A virtual machine may access memory and storage that is assigned to it but may not access memory or storage that is assigned to the host 205.

It can also be seen that the environment described in conjunction with FIG. 2 is quite flexible. Each virtual machine may be configured with whatever “virtual” hardware and software that is appropriate for a test. Furthermore, a group of virtual machines may be allowed to communicate with each other so as to provide a suitable test environment for a test.

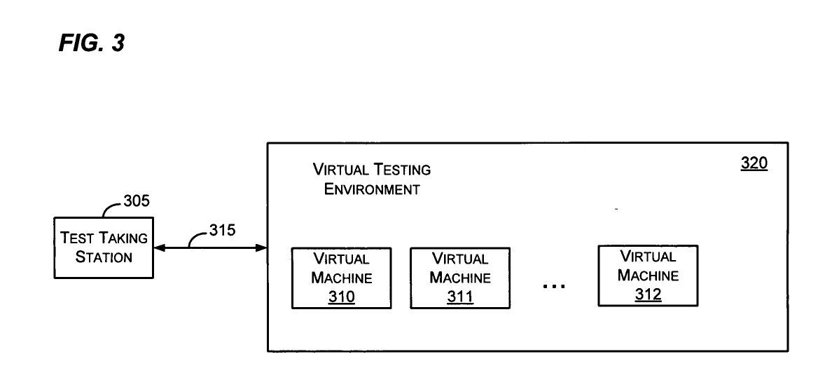

Furthermore the environment described in conjunction with FIG. 2 may be presented to a testing computer via a network connection as illustrated in FIG. 3. The testing computer may be configured to allow a test taker to view the screens of each of the virtual machines within a testing environment and to provide input to each of the virtual machines. This may be done at a greatly reduced cost compared to configuring actual physical machines with the software and network connections. A platform that is capable of creating the environments described in conjunction with FIG. 2 is the Virtual Server product available from Microsoft, Corporation.

A challenge with the testing environment described in conjunction with FIG. 2 is how to obtain testing data from the virtual machines. For security and testing purposes, the machines are not allowed to access outside resources. If the testing mechanism is built into a virtual machine, it is possible that a test taker with sufficient skill (or luck) and privileges may be able to compromise the testing system. Likewise, if a communication path to outside resources is provided during a test even for providing test results to an outside scoring engine, this pipe may be exploited by a test taker to cheat on the test or to tamper with the host 205, other computers, or other tests in progress.

To address this challenge, the host 205 may collect state from the virtual machines of a virtual environment after the test taker has completed the test. In other words, the test taker is provided with the appropriate virtual environment with no ways of tampering with the host 205 and without a communication path to directly control resources outside of the testing environment. After the test taker indicates that the test taker has completed the test, the host 205 may collect state from the virtual machines of the virtual environment.

The state collected may include such things as information from a registry or other data base, information from files including configuration files, information collected from custom software programs, other information included on a virtual hard drive, and the like. This state indicates the results of what the test taker has done and may indicate how the user obtained those results.

FIG. 3 is a block diagram representing an exemplary environment in which aspects of the subject matter described herein may be implemented. The environment includes a test taking station 305 and a virtual testing environment 320. The virtual testing environment includes virtual machines 310-312.

Where a line (e.g., the line 315) connects one entity to another, it is to be understood that the two entities may be connected (e.g., logically, physically, virtual, or otherwise) via any type of network including a direct connection, a local network, a non-local network, the Internet, some combination of the above, and the like.

The test taking station 305 and the virtual testing environment 320 may be implemented on or as one or more computers (e.g., the computer 110 as described in conjunction with FIG. 1). In one embodiment, the test taking station 305 and the virtual testing environment 320 may be implemented on the same physical machine.

The virtual machines 310-312 are similar to the virtual machines 215-218 of FIG. 2. Each of the virtual machines 310-312 is able to communicate with at least one other of the virtual machines 310-312 (unless a test dictates otherwise) but is not able to directly access resources outside of the virtual testing environment.

The test taking station 305 may provide access to the virtual machines 310-312. In providing this access, the test taking station 305 may allow a test taker to view the “desktop” (e.g., the graphical output) and/or other output of the virtual machine and allow the test taker to provide input (e.g., mouse input, keyboard input, other input, and the like), to one or more of the virtual machines 310-312. The test taking station 305 may allow the user to switch between the virtual machines 310-312 so that the user may access each virtual machine individually.

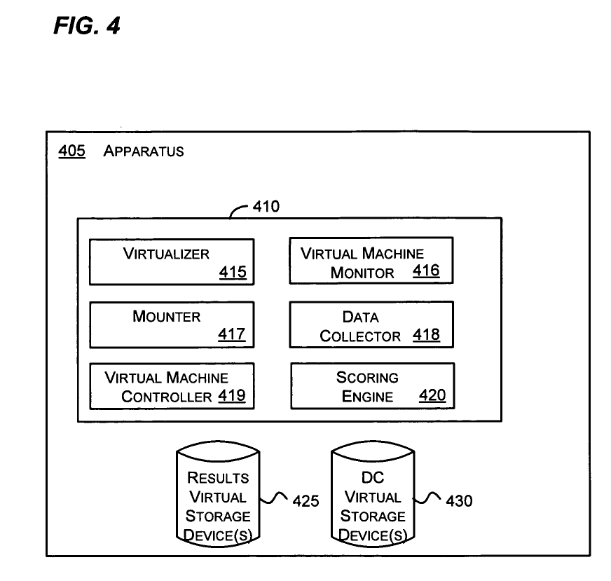

FIG. 4 is a block diagram illustrating various components that may be included in an apparatus arranged in accordance with aspects of the subject matter described herein. The components illustrated in FIG. 4 are exemplary and are not meant to be all-inclusive of components that may be needed or included. In other embodiments, the components or functions described in conjunction with FIG. 4 may be included in other components or placed in subcomponents without departing from the spirit or scope of aspects of the subject matter described herein.

Turning to FIG. 4, the apparatus 405 may include virtual testing components 410 and virtual storage devices 425 and 430. The virtual testing components 410 may include a virtualizer 415, a virtual machine monitor 416, a mounter 417, a data collector 418, a virtual machine controller 419, and a scoring engine 420.

The virtualizer 415 provides virtualized hardware to one or more virtual machines that are hosted by the apparatus 405. The virtualizer 415 restricts communication between virtual machines to the virtual machines in a virtual testing environment.

The virtual machine monitor 416 determines whether a virtual machine is executing or shut down. It may do this by checking for a process associated with a virtual machine, for example.

The mounter 417 attaches and unattaches virtual storage devices from virtual machines hosted by the apparatus 405. For example, the mounter 417 may attach a results virtual storage device 425 and a data collection virtual storage device 430 to a virtual machine hosted by the apparatus 405.

The data collector 418 operates to collect data from the virtual machines. It may do so by causing the virtual machines to be shut down and restarted (e.g., via the virtual machine controller 419), mounting virtual storage devices on virtual machines (e.g., via the mounter 417), and examining data returned in virtual storage devices (e.g., the results virtual storage device(s) 425).

The virtual machine controller 419 operates to start, restart, and shut down virtual machines. If needed, the virtual machine controller 419 may reset a virtual machine that is not responding to a shut down message.

The scoring engine 420 scores a test based on data obtained or derived by the data collector 418.

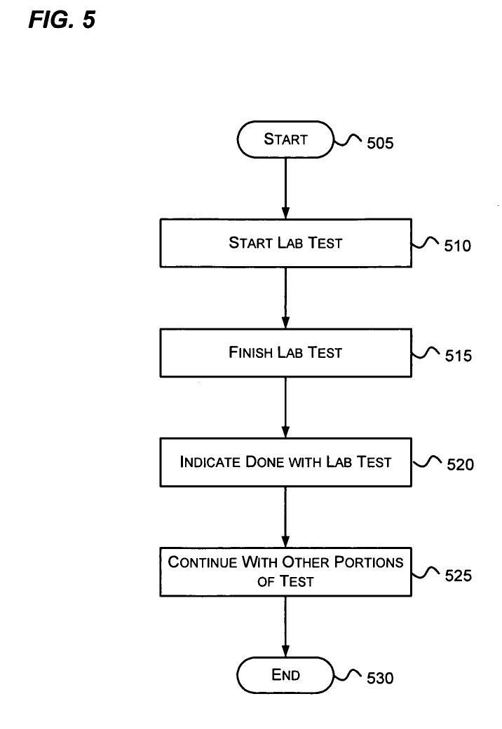

FIGS. 5-7 are flow diagrams that generally represent exemplary actions that may occur in accordance with aspects of the subject matter described herein. For simplicity of explanation, the methodology described in conjunction with FIGS. 5-7 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 5 is a flow diagram that general represents actions that may occur on a test taking station in accordance with aspects of the subject matter described herein. At block 505, the actions begin. At block 510, a lab test is started. A lab test involves a test that includes a virtual environment that includes one or more virtual machines.

At block 515, a test taker finishes or otherwise determines that the user will no longer work on the lab test. For example, referring to FIG. 3, a test taker using the test taking station 305 finishes a lab portion of a test. The lab portion of the test involves the virtual test environment 320 that includes one or more virtual machines 310-312.

At block 520, the test taker indicates that the test taker is done with the lab test. For example, referring to FIG. 3, the test taker may select a “done” button on the screen of the test taking station 305.

At block 525, the test taker continues with other portions of the test. These other portions of the test may involve tests that involve one or more virtual testing environments and/or tests that do not involve a virtual testing environment. For example, referring to FIG. 3, the test taker may take portions of the test that do not involve the virtual testing environment 320.

At block 530, the actions end.

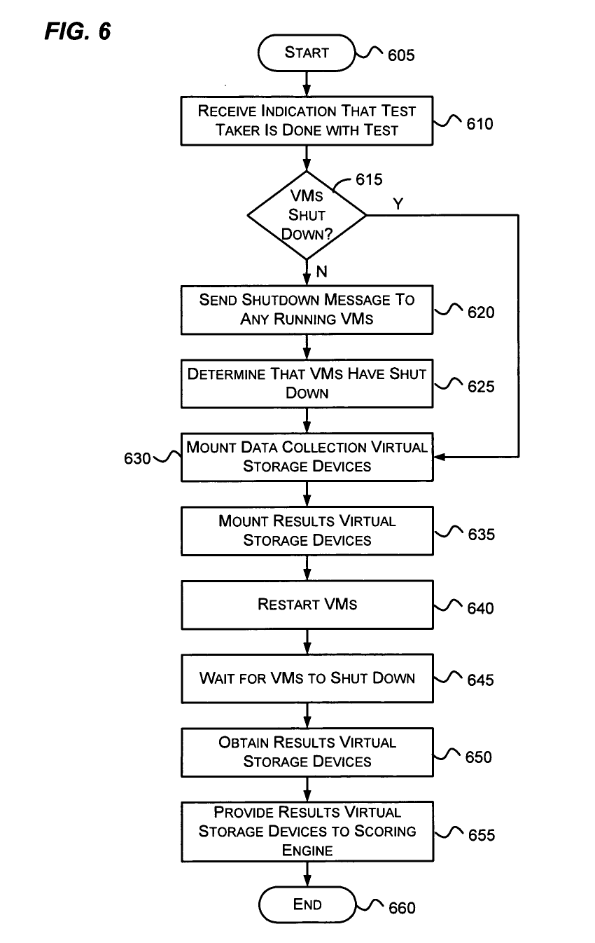

FIG. 6 is a flow diagram that generally represents exemplary actions that may be taken by an environment that hosts a virtual environment in accordance with aspects of the subject matter described herein. At block 605, the actions begin.

At block 610, an indication that a test taker is done with a portion of a test that involves a virtual environment is received. The indication that a test taker is done with a portion of the test may come from the test taker indicating through a user interface that the test taker is done, from a timer indicating that the time given to complete the test has expired, or from some other mechanism. At this point, the test taker may no longer be granted access to the virtual machines that are about to be scored. For example, referring to FIG. 4, the virtual testing components 410 receive an indication that a test taker is done with taking a test that involves the virtual environment 210 of FIG. 2.

At block 615, a determination is made as to whether the virtual machines within the testing environment are shut down. If so, the actions continue at block 630; otherwise, the actions continue at block 620. For example, referring to FIG. 4, the virtual machine monitor 416 determines whether the virtual machines in the testing environment are shut down.

At block 620, shutdown messages are sent to each running virtual machine. For example, referring to FIG. 4, the virtual machine controller 419 sends shut down messages to each virtual machine in the testing environment that is not shut down.

At block 625, a determination is made that the virtual machines have shut down. For example, referring to FIG. 4, the virtual machine monitor 416 continues to monitor the virtual machines until all of the machines have been shut down. If needed, the virtual machine controller 419 may cause a hard shut down of a virtual machine. This may be needed, for example, if the virtual machine does not respond to the shut down message sent in conjunction with block 620.

At block 630, data collection virtual storage devices are mounted on each virtual machine involved in the test. For example, referring to FIG. 4, the mounter 417 attaches (e.g., mounts) a data collection virtual storage device (e.g., a virtual hard drive) to each virtual machine involved in the test. A data collection virtual storage device may include components (e.g., programs, scripts, stored procedures, and the like) that check the state of the virtual storage device as described previously.

At block 635, results virtual storage devices are mounted on each virtual machine involved in the test. For example, referring to FIG. 4, the mounter 417 attaches a results virtual storage device to each virtual machine involved in the test. In one embodiment, the data collection components included on the data collection virtual storage device may be provided to the virtual machine by placing them in the results virtual storage device. In this embodiment, only one virtual storage device may be mounted to each virtual machine to obtain state associated with the test.

At block 640, the virtual machines are restarted. In preparation for starting the virtual machines, the boot order of the virtual storage devices attached to the virtual machine may be modified so as to execute the data collection components. For example, referring to FIG. 4, the mounter 417 may control the boot order of the virtual storage devices mounted on each virtual machine so as to cause each virtual machine to execute the data collection components included on the data collection virtual storage device. The virtual machine controller 419 may then cause the virtual machines to be restarted.

At block 645, the virtual testing components wait for the virtual machines to shut down. For example, referring to FIG. 4, the virtual testing components 410 employ the virtual machine monitor 416 to determine when the virtual machines have shut down. The data collection components may include a shut down instruction that executes when the data collection components have completed gathering the state on a virtual machine.

At block 650, the results virtual storage devices are obtained. For example, referring to FIG. 4, the data collector 418 obtains the results virtual storage devices and may extract the results contained thereon.

At block 655, the results virtual storage devices are provided to a scoring engine. For example, referring to FIG. 405, the data collector 418 passes the results virtual storage devices (or results derived therefrom) to the scoring engine 420.

At block 660, the actions end.

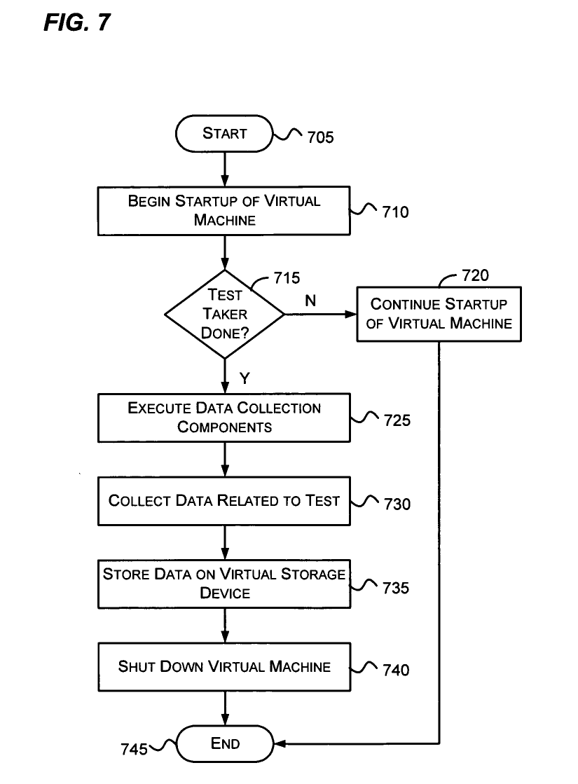

FIG. 7 is a flow diagram that generally represents exemplary actions that may occur from within a virtual machine in accordance with aspects of the subject matter described herein. At block 705, the actions being.

At block 710, a virtual machine is started. For example, referring to FIG. 4, the virtual machine controller 419 may start a virtual machine.

At block 715, a determination is made as to whether a test taker has indicated that the test taker is done with a test. If so, the actions continue at block 725; otherwise, the actions continue at block 725. For example, referring to FIG. 3, the virtual machine 310 may determine whether a results and/or data collection virtual storage devices are mounted. The virtual testing components 410 of FIG. 4 may have mounted these devices in response to receiving an indication that a test taker has completed a test, for example.

At block 720, the startup of the virtual machine is continued. For example, referring to FIG. 3, the virtual machine 310 continues to start up to prepare to interact with a test taker on the test taking station 305. If this block is reached, it indicates that a test is in progress and that the test taker has not yet indicated that the test taker is done with the test.

At block 725, data collection components are executed. For example, referring to FIG. 3, the virtual machine 310 executes data collection components from a data collection virtual storage device mounted on the virtual machine 310. Likewise, the other virtual machines 311-312 may also collect data by executed data collection components on virtual storage devices mounted thereon. Note that the data collection components mounted on each virtual machine may be different from the data collection components mounted on other virtual machines.

At block 730, data related to a test is collected. This data may include or be derived from the state information as described previously. For example, referring to FIG. 3, the virtual collection components on the data collection virtual storage device mounted on the virtual machine 310 collect data regarding the test from the virtual machine 310. The other virtual machines 310-312 in the test may also perform similar actions.

At block 735, the data is stored on a virtual storage device. For example, referring to FIG. 3, the virtual machine 310 places the data collected in conjunction with FIG. 730 on the results virtual storage device attached to the virtual machine 310. The other virtual machines 311-312 in the virtual testing environment 320 may also perform similar actions.

At block 740, the virtual machine is shut down. For, referring to FIG. 3, the virtual machine 310 may shut down after the data has been collected. The other virtual machines 311-312 of the virtual testing environment 320 may also shut down after they have collected data related to the test.

At block 745, the actions end.

As can be seen from the foregoing detailed description, aspects have been described related to secure virtual environment for providing tests to test takers. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving an indication that a test taker is done with a test;
determining that a virtual machine associated with the test is still running;
sending a shutdown message to the virtual machine;
determining that the virtual machine has shut down;
mounting a first virtual storage device on the virtual machine, the first virtual storage device to receive state about the virtual machine regarding the test; and
restarting the virtual machine.

2. The method of claim 1, further comprising, prior to restarting the virtual machine, configuring the virtual machine to collect the state and store the state on the first virtual storage device upon restarting the virtual machine.

3. The method of claim 1, further comprising mounting a second virtual storage device on the virtual machine prior to restarting the virtual machine, the second virtual storage device including information that indicates how to collect the state regarding the test from the virtual machine.

4. The method of claim 1, further comprising:
waiting for the virtual machine to shut down after restarting the virtual machine; and
providing access to the first virtual storage device to a scoring engine.

5. The method of claim 1, wherein the virtual machine is part of a virtual environment including one or more other virtual machines, each virtual machine being able to communicate with at least one other virtual machine in the virtual environment but not being able to communicate with any virtual machines outside of the virtual environment.

6. The method of claim 1, wherein the state comprises configuration information regarding the virtual machine, the configuration information being changeable by the test taker while the test taker is taking the test.

7. The method of claim 1, further comprising providing access to the virtual machine to a remote device that receives input from the test taker.

8. The method of claim 7, wherein providing access to the virtual machine to a remote device that receives input from the test taker comprises sending graphical and other output of the virtual machine to the remote device and providing the input from the test taker to the virtual machine.

9. A computer storage medium having computer-executable instructions, which when executed perform actions, comprising:
starting a virtual machine that has been part of a testing environment provided to a test taker, the virtual machine being able to communicate with other virtual machines, if any, in the testing environment;
determining if there is an indication that the test taker is done with a test; and
if there is an indication that the test taker is done with a test, performing actions, comprising:
collecting data related to the test that has been given using the virtual machine, the data derived from state of the virtual machine,
storing the data on a first virtual storage device, and
causing the virtual machine to shut down after the data is stored a first virtual storage device.

10. The computer storage medium of claim 9, further comprising if there is no indication that the test taker is done with the test, completing the starting the virtual machine to continue to the test.

11. The computer storage medium of claim 9, wherein determining if there is an indication that the test taker is done with a test comprises determining whether the first virtual storage device has been mounted on the virtual machine, the virtual storage device being mounted on the virtual machine only if a testing component has received input indicating that the user is done with the test.

12. the computer storage medium of claim 9, wherein collecting data related to the test that has been given using the virtual machine comprises locating data collection information on a second virtual storage device, the data collection information indicating actions to take to collect the data, the storage device being mounted on the virtual machine after the indication that the test taker is done with the test is received and before the starting of the virtual machine.

13. The computer storage medium of claim 12, wherein the first virtual storage device and the second virtual storage device are unaccessible by the test taker during the test and while scoring is being completed.

14. The computer storage medium of claim 9, wherein the testing environment includes a plurality of virtual machines, each of which are able to communicate with at least one other of the virtual machines other but each of which are unable to directly control entities outside of the testing environment.

15. The computer storage medium of claim 9, wherein the virtual machine presents virtualized hardware to software that executes in the virtual machine such that the software is unable to detect a difference between executing in the virtual environment and executing on a physical machine having physical hardware corresponding to the virtualized hardware.

16. The computer storage medium of claim 9, wherein the test comprises configuring the virtual machine and the other virtual machines, if any, in the virtual environment according to instructions provided to the test taker.

17. In a computing environment, an apparatus, comprising:
a virtualizer operable to provide virtualized hardware to one or more virtual machines, the virtualizer restricting the one or more virtual machines to communications with each other;
a virtual machine monitor that monitors execution state of the one or more virtual machines;
a mounter operable to attach and unattach virtual hard drives to the one or more virtual machines; and
a data collector operable to obtain data regarding a test conducted in the virtual environment.

18. The apparatus of claim 17, further comprising a virtual machine controller 419 operable to shut down and start the one or more virtual machines.

19. The apparatus of claim 17, further comprising a scoring engine operable to calculate a test results based at least in part on the data.

20. The apparatus of claim 17, further comprising a results virtual storage device for storing the data regarding the test.
